(19) United States
(12) Patent Application Publication
(10) Pub. No.: US 2006/0208976 A1
(43) Pub. Date: Sep. 21, 2006

(54) Active matrix type display device and driving method thereof

(75) Inventor: Kouji Ikeda, Gifu (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/366,808

(22) Filed: Mar. 3, 2006

(30) Foreign Application Priority Data
Mar. 11, 2005 (JP) 2005-068811

(51) Int. Cl. G09G 3/30

(52) U.S. Cl. 345/76

(57) ABSTRACT

A residual image effect is suppressed to improve quality of display of an active matrix type display device. An electric potential switching circuit switches an electric potential on a capacitor line from a first capacitor electric potential (ground electric potential, for example) to a second capacitor electric potential (power supply electric potential, for example) during a blanking period. At that time, an electric potential at a gate of a driver transistor is raised by capacitive coupling through a storage capacitor. As a result, the electric potential at the gate of the driver transistor becomes higher than an electric potential at a source of the driver transistor. Assuming that holes are trapped in a gate insulation film of the driver transistor due to writing-in of a display signal during a preceding frame period, the holes are extracted from the gate insulation film to the source or a drain of the driver transistor. With this, electric characteristics of the driver TFT are initialized. And the electric potential switching circuit switches the electric potential on the capacitor line back to the first capacitor electric potential from the second capacitor electric potential before an end of the blanking period.

### CROSS-REFERENCE OF THE INVENTION

This invention is based on Japanese Patent Application No. 2005-068811, the content of which is incorporated herein by reference in its entirety.

### BACKGROUND OF THE INVENTION

1. Field of the Invention

This invention relates to an active matrix type display device and a driving method thereof.

2. Description of the Related Art

Organic EL display devices using organic electroluminescent devices (hereafter referred to as organic EL devices) have been developed in recent years as display devices to replace CRT and LCD. An emphasis is laid on development of an active matrix type organic EL display device that uses a thin film transistor (hereafter referred to as TFT) as a switching device to drive the organic EL device.

The active matrix type organic EL display device will be explained hereinafter, referring to the drawing. FIG. 4 is an equivalent circuit diagram of the organic EL display device. Only one display pixel 210 is shown in FIG. 4 out of a plurality of display pixels arrayed in a matrix form in a display panel of the organic EL display device.

An N-channel type pixel selection TFT 213 is disposed around an intersection of a pixel selection signal line 211 extending in a row direction and a display signal line 212 extending in a column direction. A gate of the pixel selection TFT 213 is connected to the pixel selection signal line 211, while a drain of the pixel selection TFT 213 is connected to the display signal line 212. The pixel selection TFT 213 is turned on according to a high level of a pixel selection signal G, which is outputted from a vertical drive circuit 301 and applied to the pixel selection signal line 211. A display signal D is outputted from a horizontal drive circuit 302 to the display signal line 212.

A source of the pixel selection TFT 213 is connected to a gate of a P-channel type driver TFT 214. A source of the driver TFT 214 is connected to a power supply line 215 that supplies a positive power supply electric potential PVdd. A drain of the driver TFT 214 is connected to an anode of an organic EL device 216. A negative power supply electric potential CV is supplied to a cathode of the organic EL device 216.

A storage capacitor 218 is connected between the gate of the driver TFT 214 and a capacitor line 217. The capacitor line 217 is fixed to a constant electric potential. The storage capacitor 218 retains the display signal D applied to the gate of the driver TFT 214 through the pixel selection TFT 213 for one horizontal period.

Next, an operation of the organic EL display device described above will be explained. The pixel selection TFT 213 is turned on when the high level of the pixel selection signal G, which lasts for one horizontal period, is applied to the pixel selection line 211. Then the display signal D outputted to the display signal line 212 is applied to the gate of the driver TFT 214 through the pixel selection TFT 213 and retained by the storage capacitor 218. In other words, the display signal D is written into the display pixel 210.

A conductance of the driver TFT 214 varies according to the display signal D applied to the gate of the driver TFT 214. When the driver TFT 214 is turned on, it provides the organic EL device 216 with an electric current corresponding to the conductance and the organic EL device 216 is driven to a brightness level corresponding to the electric current. On the other hand, when the driver TFT 214 is turned off in response to the display signal D supplied to its gate, the organic EL device 216 is turned off since no electric current flows through the driver TFT 214.

A desired image can be displayed on the entire display panel by performing the operation described above for all the rows of the display pixels 210 over one frame period.

Further description on the technologies mentioned above is provided in Japanese Patent Application Publication No. 2004-341435.

With the organic EL display device described above, however, there is a problem of deterioration in quality of display, which is caused on a part of the display panel by a residual image due to light emission of the organic EL device 216. That is because an electric current of a current value different from a current value expected according to the display signal D, that is written into the driver TFT 214 in a certain display pixel in a current frame period, flows through the driver TFT 214, depending on a conduction status (ON status or OFF status) of the driver TFT 214 into which the display signal D in a preceding frame period has been written. In other words, the electric current that flows through the driver TFT 214 exhibits hysteresis. The hysteresis is particularly apparent when the display signal D is at an intermediate level between a high level and a low level.

### SUMMARY OF THE INVENTION

The invention provides an active matrix type display device that includes a plurality of display pixels arrayed in a matrix form. Each of the display pixels includes a pixel selection transistor that is turned on according to a pixel selection signal, a light-emitting device, a driver transistor that drives the light-emitting device according to a display signal applied through the pixel selection transistor and a storage capacitor that is connected between a gate of the driver transistor and a capacitor line and retains the display signal. The display device also includes an electric potential switching circuit that switches an electric potential of the capacitor line from a first capacitor electric potential to a second capacitor electric potential that is different from the first capacitor electric potential during a blanking period to turn the driver transistor off and switches the electric potential of the capacitor line back from the second capacitor electric potential to the first capacitor electric potential before an end of the blanking period.

The invention also provides a method of driving an active matrix type display device that displays images based on a repetition of an image display period and a blanking period. The method includes providing a plurality of display pixels each comprising a pixel selection transistor, a light-emitting device, a driver transistor driving the light-emitting device and a storage capacitor connected between a gate of the driver transistor and a capacitor line, switching an electric potential of the capacitor line from a first capacitor electric potential to a second capacitor electric potential that is different from the first capacitor electric potential during the blanking period to turn the driver transistor off, switching the electric potential of the capacitor line back from the second capacitor electric potential to the first capacitor electric potential, and applying a display signal supplied through the pixel selection transistor to the driver transistor according to a pixel selection signal during the image display period after an end of the blanking period.

### BRIEF DESCRIPTION OF THE DRAWINGS

FIG. 1 is an equivalent circuit diagram showing an organic EL display device according to an embodiment of this invention.

FIG. 2 is a timing chart showing a driving method of the organic EL display device according to the embodiment of this invention.

FIG. 3 is an equivalent circuit diagram showing an organic EL display device according to another embodiment of this invention.

FIG. 4 is an equivalent circuit diagram showing an organic EL display device according to a prior art.

### DETAILED DESCRIPTION OF THE INVENTION

According to a study conducted by the inventors, the hysteresis described above is considered to be due to a change in a threshold voltage of the driver TFT 214 caused by carriers (holes) trapped in a gate insulation film of the driver TFT 214 when the display signal D is written-in during the preceding frame period. The following embodiments are made in light of this finding.

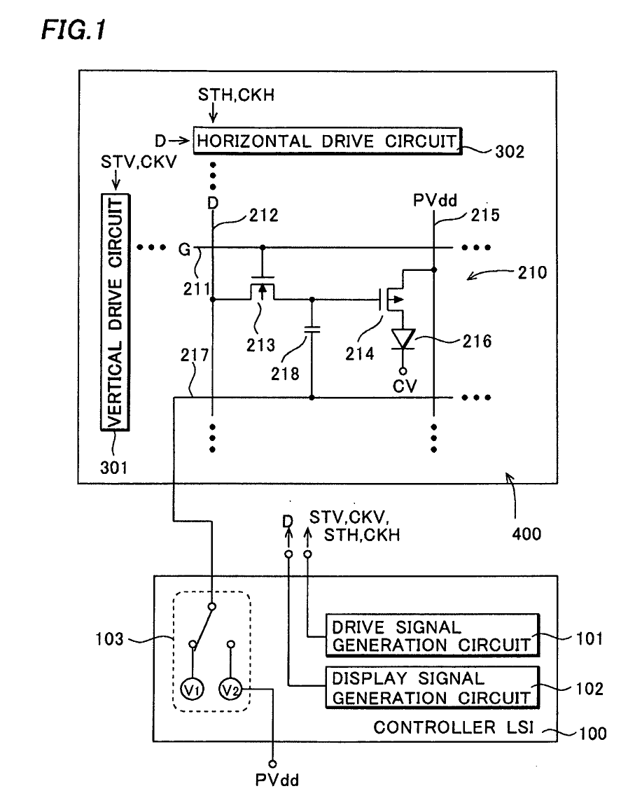

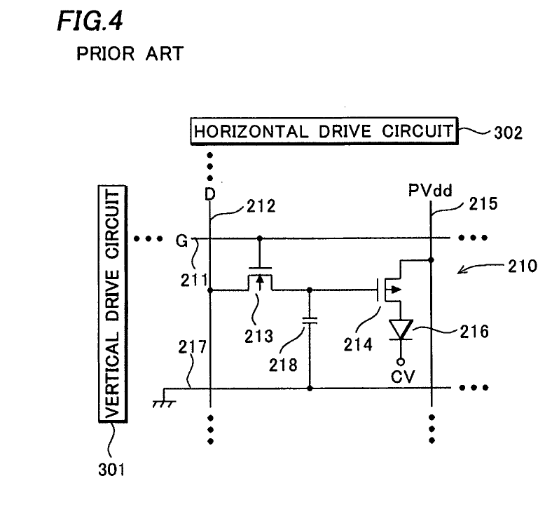

An active matrix type organic EL display device and a driving method thereof according to an embodiment of this invention will be described hereafter referring to the drawings. FIG. 1 is an equivalent circuit diagram of the organic EL display device. Only one display pixel 210 is shown in FIG. 1 out of a plurality of display pixels arrayed in a matrix form in a display panel 400 of the organic EL display device. The same components in FIG. 1 as in FIG. 4 are denoted by the same symbols, and the explanations thereof are omitted.

A controller LSI 100 that serves as a controller circuit for the display panel 400 is connected with a vertical drive circuit 301 and a horizontal drive circuit 302 in the display panel 400 as well as with a capacitor line 217 in the display pixel 210.

The controller LSI 100 includes a drive signal generation circuit 101 that generates drive signals such as a vertical start pulse signal STV, a vertical clock CKV, a horizontal start pulse signal STH and a horizontal clock CKH and a display signal generation circuit 102 that sequentially outputs display signals D corresponding to images to be displayed.

The controller LSI 100 further includes an electric potential switching circuit 103 that is connected with the capacitor line 217. The electric potential switching circuit 103 switches an electric potential on the capacitor line 217 from a first capacitor electric potential V1 to a second capacitor electric potential V2 that is higher than the first capacitor electric potential V1 during a blanking period to turn a driver TFT 214 off during a blanking period and switches the electric potential on the capacitor line 217 back to the first capacitor electric potential V1 from the second capacitor electric potential V2 before the end of the blanking period.

An OFF state of the driver TFT 214 resulted from the switching of the capacitor line 217 does not necessarily mean a complete OFF state. It means that the driver TFT 214 is not in a complete ON state, as an extent of the OFF state of the driver TFT 214 is controlled according to an electric potential applied to its gate.

In this embodiment, it is preferable that the first capacitor electric potential V1 is a ground electric potential, i.e. 0, and the second capacitor electric potential V2 is a positive power supply electric potential PVdd, for example, 7-8V, of a power supply line 215.

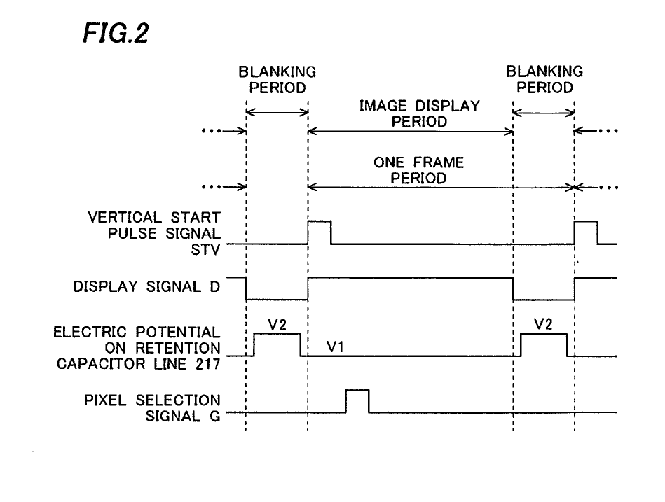

Next, a driving method of the organic EL display device described above will be explained referring to the drawings. FIG. 2 is a timing chart to explain the driving method of the organic EL display device according to the embodiment.

The electric potential switching circuit 103 outputs the first capacitor electric potential V1 during an image display period and switches from the first capacitor electric potential V1 to the second capacitor electric potential V2 to raise the electric potential on the capacitor line 217 to the second capacitor electric potential V2 during the blanking period, as shown in FIG. 2.

Then the electric potential at the gate of the driver TFT 214 is raised by capacitive coupling through the storage capacitor 218, in response to a voltage change ΔV from the first capacitor electric potential V1 to the second capacitor electric potential V2. As a result, the electric potential at the gate of the driver TFT 214 becomes higher than an electric potential at its source and becomes higher than a threshold voltage of the driver TFT 214 as well, turning the driver TFT 214 to the OFF state. At that time, assuming that carriers (holes) have been trapped in a gate insulation film of the driver TFT 214 by writing-in of the display signal D during the preceding frame period, the carriers (holes) are extracted from the gate insulation film to the source or a drain of the driver TFT 214 as a tunnel current induced by an electric field from the gate to the source or the drain. With this, electric characteristics of the driver TFT 214 are initialized.

Next, the electric potential switching circuit 103 switches the electric potential on the capacitor line 217 back to the first capacitor electric potential V1 from the second capacitor electric potential V2 before the end of the blanking period. As a result, the electric potential at the gate of the driver TFT 214 returns to the original state and the storage capacitor 218 resumes the status in which the original display signal D is retained.

After the end of the blanking period, when it turns into the image display period, a vertical start pulse signal STV is outputted from the drive signal generation circuit 101 in the controller LSI 100 to the vertical drive circuit 301. The vertical start pulse signal STV is shirted by the vertical drive circuit 301 in synchronization with the vertical clock CKV to output the pixel selection signal G of high level, and a corresponding pixel selection TFT 213 is turned on for one horizontal period. During the one horizontal period, the display signal D is outputted from the horizontal drive circuit 302 to a display signal line 212 in the display pixel 210 in synchronization with the horizontal start pulse signal STH (not shown in FIG. 2) that is outputted from the drive signal generation circuit 101 to the horizontal drive circuit 302. The display signal D is applied to the gate of the driver TFT 214 through the pixel selection TFT 213 and retained in the storage capacitor 218. An electric current corresponding to the display signal D is supplied from the driver TFT 214 to an organic EL device 216 and drives the organic EL device 216 to emit light.

According to the embodiment, as described above, the residual image on the display panel 400 can be suppressed to improve the quality of the display, since the carriers (holes) in the gate insulation film of the driver TFT 214 are extracted to initialize the electric characteristics of the driver TFT 214 during the blanking period in which the display signal D is not outputted to the display signal line 212.

Although the organic EL device 216 is used as a light-emitting device in the embodiment described above, other light-emitting devices such as an inorganic EL device and a light-emitting diode may be used instead.

Also, although the pixel selection TFT 213 is an N-channel type TFT and the driver TFT 214 is a P-channel type TFT in the embodiment described above, these TFTs may be of other channel conductivity types. In the case where the driver TFT 214 is an N-channel type TFT, the second capacitor electric potential V2 is set to be lower than the first capacitor electric potential V1, contrary to the above embodiment.

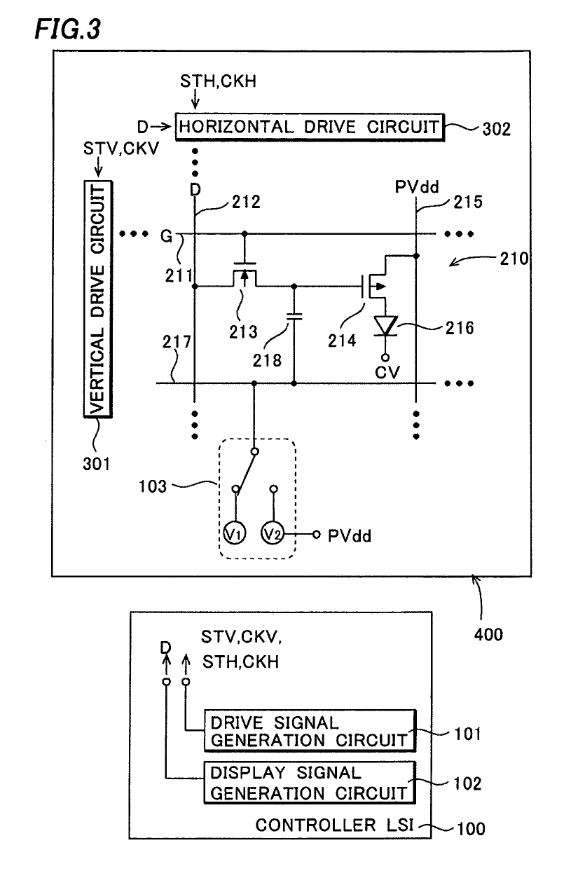

Furthermore, although the electric potential switching circuit 103 is disposed in the controller LSI 100 in the embodiment described above, it may be disposed in the display panel 400, as shown in an equivalent circuit diagram shown in FIG. 3.

In the embodiments above, electric characteristics of the driver transistor, especially a threshold voltage, can be restored to an initial state before the display signal is written into the display pixel, because carriers trapped in a gate insulation film of the driver transistor are extracted to the source or the drain of the driver transistor. As a result, an adequate electric current corresponding to the display signal flows through the driver transistor always, enabling suppression of the residual image on a display panel.

What is claimed is:

1. An active matrix type display device comprising:
a plurality of display pixels arrayed in a matrix form, each of the display pixels comprising a pixel selection transistor that is turned on according to a pixel selection signal, a light-emitting device, a driver transistor that drives the light-emitting device according to a display signal supplied through the pixel selection transistor and a storage capacitor that is connected between a gate of the driver transistor and a capacitor line and retains the display signal; and
an electric potential switching circuit that switches an electric potential of the capacitor line from a first capacitor electric potential to a second capacitor electric potential that is different from the first capacitor electric potential during a blanking period to turn the driver transistor off and switches the electric potential of the capacitor line back from the second capacitor electric potential to the first capacitor electric potential before an end of the blanking period.

2. The active matrix type display device of claim 1, wherein the second capacitor electric potential is higher than the first capacitor electric potential.

3. The active matrix type display device of claim 2, wherein the second capacitor electric potential is equal to a power supply electric potential that is supplied to the light-emitting device.

4. The active matrix type display device of claim 3, wherein the first capacitor electric potential is equal to a ground electric potential.

5. The active matrix type display device of claim 1, 2, 3 or 4, wherein the light-emitting device comprises an organic electroluminescent device.

6. A method of driving an active matrix type display device that displays images based on a repetition of an image display period and a blanking period, comprising:
providing a plurality of display pixels each comprising a pixel selection transistor, a light-emitting device, a driver transistor driving the light-emitting device and a storage capacitor connected between a gate of the driver transistor and a capacitor line;
switching an electric potential of the capacitor line from a first capacitor electric potential to a second capacitor electric potential that is different from the first capacitor electric potential during the blanking period to turn the driver transistor off;
switching the electric potential of the capacitor line back from the second capacitor electric potential to the first capacitor electric potential; and
applying a display signal supplied through the pixel selection transistor to the driver transistor according to a pixel selection signal during the image display period after an end of the blanking period.

7. The method of claim 6, wherein the second capacitor electric potential is higher than the first capacitor electric potential.

8. The method of claim 7, wherein the second capacitor electric potential is equal to a power supply electric potential that is supplied to the light-emitting device.

9. The method of claim 8, wherein the first capacitor electric potential is equal to a ground electric potential.

10. The method of claim 6, 7, 8 or 9, wherein the light-emitting device comprises an organic electro luminescent device.
